(19) United States
(12) Patent Application Publication
(10) Pub. No.: US 2026/0338003 A1
(43) Pub. Date: Oct. 29, 2026

(54) CHARGER

(71) Applicant: LG ELECTRONICS INC., Seoul (KR)

(72) Inventors: Younghoon Kim, Seoul (KR); Cheolsoo KIM, Seoul (KR)

(73) Assignee: LG ELECTRONICS INC., Seoul (KR)

(21) Appl. No.: 19/109,038

(22) PCT Filed: Dec. 12, 2023
(86) PCT No.: PCT/KR2023/020432

§ 371 Date: Mar. 5, 2025

(51) Int. Cl. E05B 47/00; B60L 53/31; B60L 53/68

(52) U.S. Cl. CPC E05B 47/0012; B60L 53/31; B60L 53/68; E05B 2047/0017; E05B 2047/002; E05B 2047/0067

(57) ABSTRACT

A charger comprises: a charger body provided with a space; a door for opening and closing the space; a bracket; a wheel rotatably disposed on the bracket and having a connecting rod; a driving source rotating the wheel; a lever having a long hole through which the connecting rod is guided and moved linearly by the wheel and locked or unlocked on the door; and a sensor sensing the lever.

### TECHNICAL FIELD

The present disclosure relates to a charger.

### BACKGROUND ART

A charger is a device used to charge a battery.

An example of a charger may be an electric vehicle charger that charges a vehicle such as an electric vehicle, and electric energy is supplied to the battery of the electric vehicle by connecting the charging connector provided at the end of the charging cable to the connection inlet installed in the electric vehicle.

The charger comprises a power module connected to a charging cable and a charger body that forms a space for accommodating the power module, and in order to use the charging cable, the wound charging cable is unwound and pulled out, and then used.

A locking device may be installed in the charger, and an example of a charger with a locking device is an electric vehicle charging device disclosed in Korean Patent Publication No. 10-1384613 B1 (Apr. 11, 2014, published), which comprises a charger body that supplies power to an electric vehicle through a charging cable; a storage box for storing a charging cable installed on the left or right side of the charger body; and a locking device installed for opening and closing the door of the storage box; wherein, when payment for the charging demand is made through a user interface unit and a card recognition unit provided in the charger body, the locking device determines that the user is an authenticated user and opens the door of the storage box, and when the door is recognized as being locked, the payment processing result is output and the door is locked at the same time.

### DISCLOSURE

### Technical Problem

The present embodiment provides a charger that allows the door to be easily opened and closed without a locking tool such as a key.

### Technical Solution

A charger comprises a charger body provided with a space; a door for opening and closing the space; a bracket; a wheel rotatably disposed on the bracket and having a connecting rod; a driving source rotating the wheel; a lever having a long hole through which the connecting rod is guided and moved linearly by the wheel and locked or unlocked on the door; and a sensor sensing the lever.

The lever may be seated to the bracket.

A guide portion for guiding the lever to slide may be formed on the bracket.

A guide rail may be formed on the guide portion and the guide is long in the longitudinal direction of the bracket,

A protrusion portion inserted into the guide rail may be formed on the lever.

The long hole may be orthogonal to the moving direction of the lever.

The driving source comprises a motor; a motor cover covering the motor; and a worm gear rotated by the motor,

The motor may be a brushed motor rotating the worm gear in one direction.

The wheel may be a worm wheel engaged with the worm gear. The worm wheel may comprise a large diameter portion from which the connecting rod protrudes; and a small diameter portion from which a gear engaged with the worm gear is formed on the outer periphery and which protrudes from the large diameter portion.

The connecting rod may be closer to a rim of the wheel among a center and the rim of the wheel.

The sensor may comprise a photo sensor in which a light emitting portion and a light receiving portion are disposed separately.

A protruding body may be protruded from the lever.

The protruding body may be positioned between the light emitting portion and the light receiving portion when the lever is in the unlocked position,

The protruding body may be positioned other than between the light emitting portion and the light receiving portion when the lever is in the locked position.

The charger may further comprise a display disposed on at least one of the door or the charger body and having an input interface.

The charger may further comprise a communication module communicating with a server.

The charger further may comprise a processor.

The processor may output a control signal to the motor if the door locking or door unlocking is input through the input interface.

The processor may output a control signal to the motor if a signal of door locking or door unlocking is received through the communication module.

### Advantageous Effect

According to the present embodiment, a motor can be rotated in one direction by a connecting rod formed in a wheel and a long hole formed on a lever to move the lever to a locking position or an unlocking position, and a door can be locked or unlocked with a simple structure and low cost.

In addition, a manager can lock or unlock the door through a display without an unlocking tool such as a key.

In addition, a manager can lock or unlock the door remotely.

In addition, since the locker is hidden by the door before the door is opened, the appearance of the charger can be improved.

### DESCRIPTION OF DRAWINGS

FIG. 1 is a perspective view of a charger according to the present embodiment,

FIG. 2 is a perspective view illustrating a locker according to the present embodiment,

FIG. 3 is a front view of a locker according to the present embodiment,

FIG. 4 is a rear view of a locker according to the present embodiment,

FIG. 5 is a view illustrating a locking mode of a locker according to the present embodiment,

FIG. 6 is a view illustrating an unlocking mode of a locker according to the present embodiment,

FIG. 7 is an enlarged perspective view of the front of a locker according to the present embodiment,

FIG. 8 is a front view when a sensor according to the present embodiment does not detect a lever,

FIG. 9 is a front view when a sensor according to the present embodiment detects a lever,

FIG. 10 is a control block diagram of a charger according to the present embodiment.

### BEST MODE

Hereinafter, specific embodiments of the present invention will be described in detail with reference to the drawings.

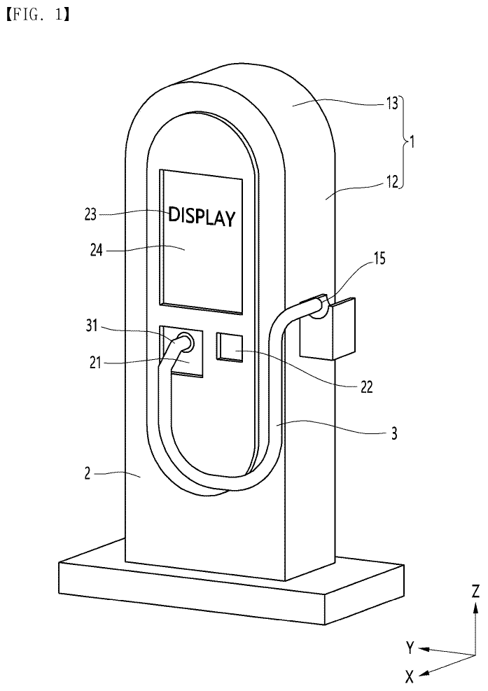

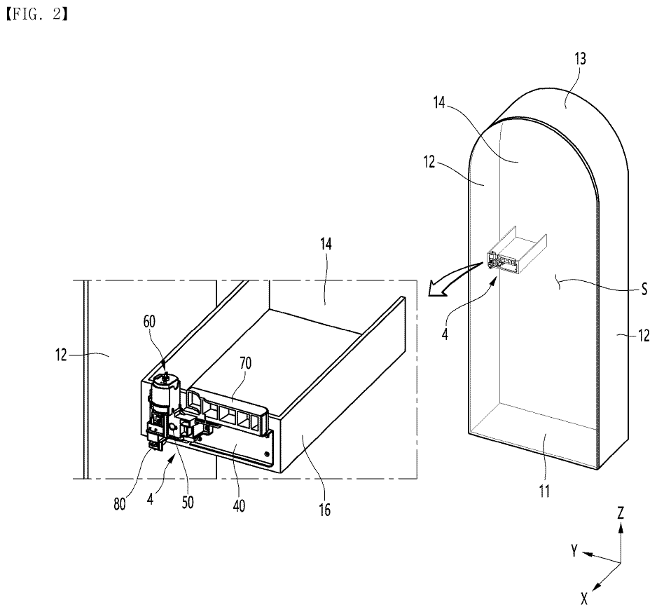

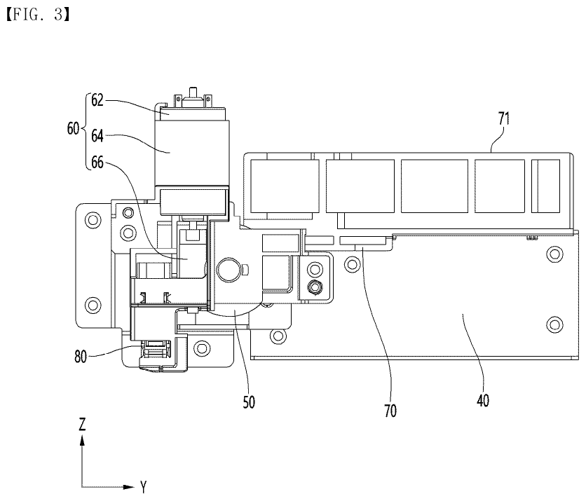

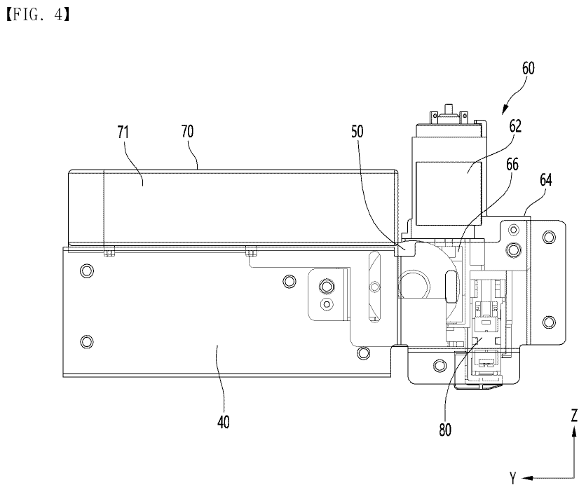

FIG. 1 is a perspective view of a charger according to the present embodiment, FIG. 2 is a perspective view illustrating a locker according to the present embodiment, FIG. 3 is a front view of a locker according to the present embodiment, and FIG. 4 is a rear view of a locker according to the present embodiment,

The charger may comprise a charger body 1 in which a space S is formed, a door 2 for opening and closing the space S, and a charging cable 3.

The charger body 1 may form the exterior of the charger. One surface of the charger body 1 may be open. The front surface of the charger body 1 may be open. The manager may service various components accommodated inside the charger body 1 through the front of the charger body 1.

The charger body 1 may comprise a base 11, a pair of side bodies 12 erected on the base 11, an upper body 13 disposed on the upper side of the pair of side bodies 12, and a rear body 14 connecting the rear ends of the pair of side bodies 12.

The space S may be formed between the pair of side bodies 12, and a power module connected to the charging cable 3 may be accommodated in the space S.

An opening 15 through which a charging cable 3 passes may be formed in the charger body 1. The opening 15 may be formed in one of a pair of side bodies 12.

The door 2 may be disposed to rotate or slide in the charger body 1.

The door 2 may be a front door disposed in the front of the charger body 1 to open and close a space S.

A holder 21 on which a connector 31, for example, a charging gun of the charger 3 is placed may be disposed in the door 2.

An authentication module 22 for a user to pay a charging fee, etc. may be disposed in the door 2.

A display 23 may be disposed in at least one of the charger body 1 and the door 2.

The display 23 may comprise an input interface 24 such as a touch screen or a button.

A connection port connected to a power module may be formed at one end of the charging cable 3, one side of the charging cable 3 may pass through an opening 15, and a connector 31 connected to or disconnected from a vehicle such as an electric vehicle may be disposed at the other end of the charging cable 3.

The charger may comprise a locker 4, shown in FIGS. 2 to 4.

The locker 4 may lock or unlock the door 2.

The locker 4 may be disposed to be hidden by the door 2. The locker 4 may be disposed in the charger body 1. The locker 4 may be accommodated in a space S2. The charger body 1 may further comprise a locker mounter 16, shown in FIG. 2 on which the locker 4 is mounted.

When the door 2 is closed, the locker 4 may be positioned on the rear surface of the door 2, and the locker 4 may lock or unlock the door 2 on the rear surface of the door 2.

The locker 4 may comprise a bracket 40, a wheel 50, a driving source 60, a lever 70, and a sensor 80.

The bracket 40 may be disposed on the rocker mounter 16. The bracket 40 may be disposed on the front surface of the rocker mounter 16 using a fastening member such as a screw. The bracket 40 may be elongated in the left and right direction Y.

The wheel 50 may be rotatably disposed on the bracket 40 or the rocker mounter 16.

The driving source 60 may rotate the wheel 50.

The driving source 60 may comprise a motor 62; a motor cover 64 covering the motor 62; and a worm gear 66 rotated by the motor 62.

The lever 70 may be moved linearly by the wheel 50. The lever 70 may be moved left and right direction Y by the wheel 50. The lever 70 may lock or unlock the door 2.

The lever 70 may comprise a locking body 71, shown in FIGS. 3 and 4 that is locked or unlocked to the door 2.

The lever 70 may be seated on the bracket 40, and the locking body 71 may be slid left and right direction Y on the upper side of the bracket 40.

The sensor 80 may sense the lever 70. The sensor 80 may be disposed on the bracket 40 or the rocker mounter 16 to sense the position of the lever 70.

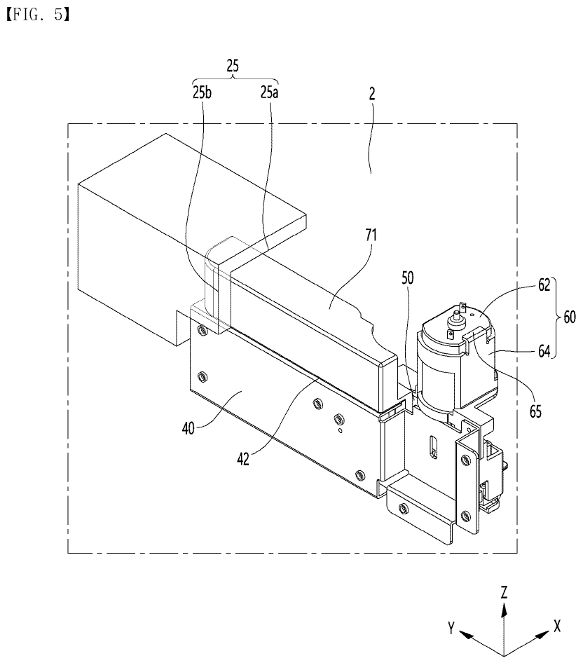

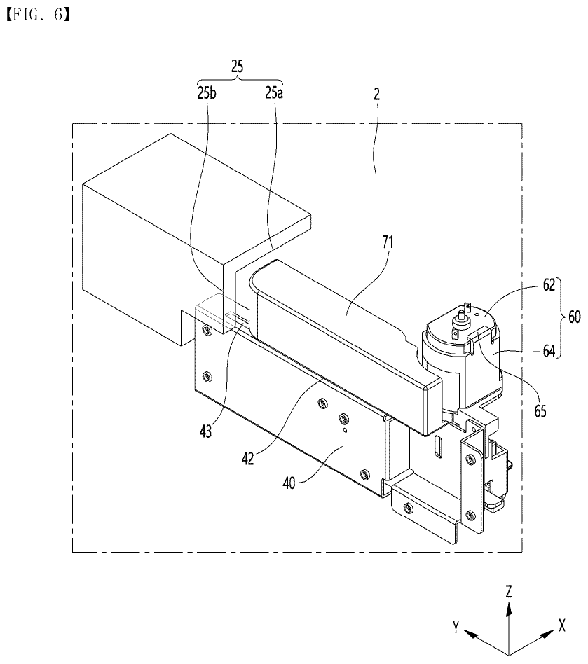

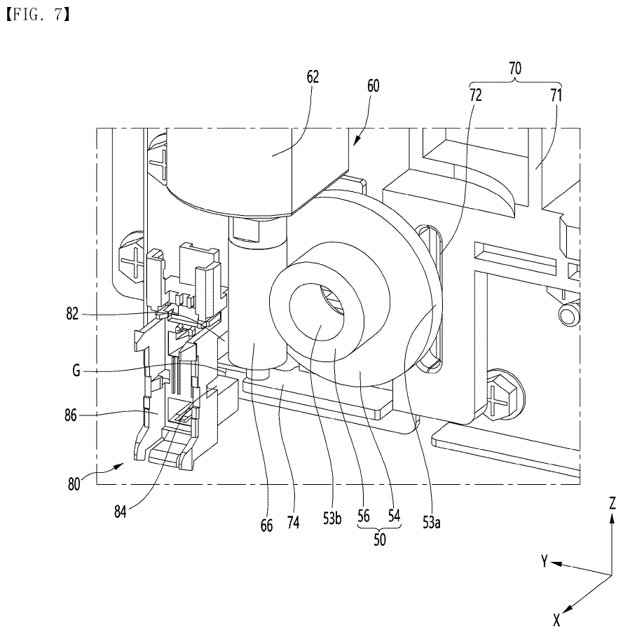

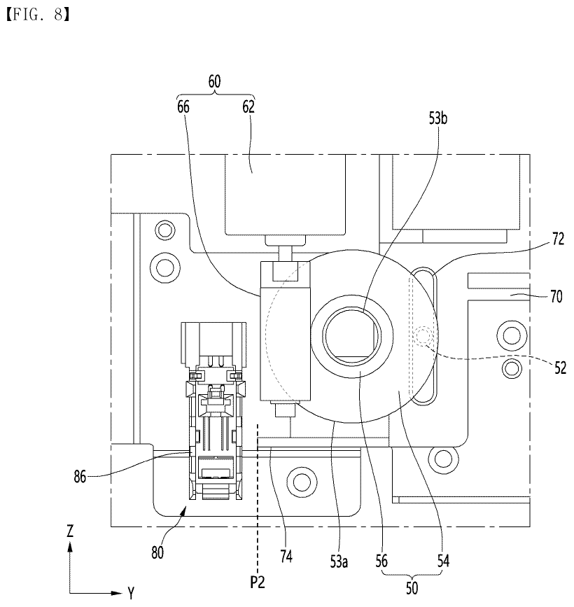

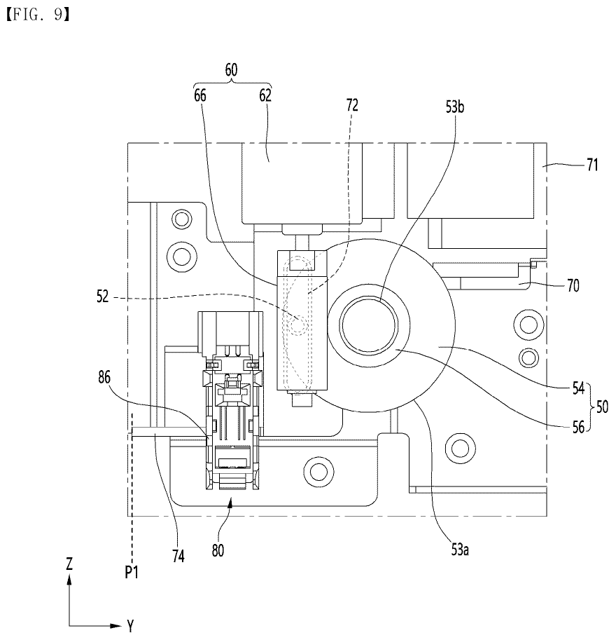

FIG. 5 is a view illustrating a locking mode of the locker according to the present embodiment, FIG. 6 is a view illustrating an unlocking mode of the locker according to the present embodiment, FIG. 7 is a perspective view illustrating an enlarged front view of the locker according to the present embodiment, FIG. 8 is a front view when the sensor according to the present embodiment does not detect the lever, and FIG. 9 is a front view when the sensor according to the present embodiment detects the lever.

A pocket 25 may be formed on the rear surface of the door 2.

The pocket 25 may be a portion where the lever 70 is locked or unlocked. The pocket 25 may protrude rearward from the rear surface of the door 2. The pocket 25 may be a portion where the lever 70 is caught in the front and rear direction X.

The pocket 25 may have a three-dimensional shape, and a pocket space may be formed inside the pocket 25 into which a portion of the lever 70, that is, a portion of the locking body 71, may be inserted.

The pocket 25 may comprise a horizontal body 25a protruding rearwardly from the rear surface of the door 2 and a vertical body 25b bent up and down direction at the rear end of the horizontal body 25a.

The vertical body 25b may be spaced apart from the rear surface of the door 2 in the front and rear direction X.

A guide portion 42 may be formed on the bracket 40 to guide the lever 70 to slide. The guide portion 42 may be bent horizontally at the upper portion of the bracket 40. The guide portion 42 may be bent forwardly at the upper portion of the bracket 40. The guide portion 42 may be formed long in the left and right direction Y.

A guide rail 43, shown in FIG. 6 may be formed in the guide portion 42.

The guide rail 43 may be elongated in the longitudinal direction Y of the bracket 70. The guide rail 43 may be formed to be elongated in the left and right direction Y.

A connecting rod 52, shown in FIGS. 8 and 9 may be formed in the wheel 50. The connecting rod 52 may be closer to the rim 53a of the wheel 50 of the center and the rim 53a of the wheel 50.

The wheel 50 may be rotatably connected to the bracket 40 with a rotation axis. A hollow portion 53b to which the rotation axis is connected may be formed in the center of the wheel 50.

The connecting rod 52 may be positioned closer to the rim 53a among the rim 53a and the hollow portion 53b.

The wheel 50 may be a worm wheel engaged with a worm gear 66. The worm wheel may comprise a large diameter portion 54 and a small diameter portion 56.

A connecting rod 52 may protrude from the large diameter portion 54. The connecting rod 52 may protrude backward from the rear surface of the large diameter portion 54.

The small diameter portion 56 may protrude from the large diameter portion 54. The small diameter portion 56 may protrude forward from the front surface of the large diameter portion 54. A gear engaged with a worm gear 66 may be formed on the outer periphery of the small diameter portion 56.

The motor 62 may be a one-way motor that rotates the worm gear 66 in one direction, and may be a brushed motor.

The motor 62 may be mounted on the motor cover 64 and may rotate the worm gear 66. A rotational shaft connected to the rotational center of the worm gear 66 may be disposed at the lower portion of the motor 62. The rotational shaft may be elongated in the up and down direction Z.

The motor cover 64 may be fastened to the bracket 40 or the rocker mounter 16 with a fastening member such as a screw. A hook 65, shown in FIGS. 5 and 6 that restrains the motor 62 may be formed on the motor cover 64.

The worm gear 66 may be formed to be elongated in the up and down direction Z. The worm gear 66 may be positioned below the motor 62. The worm gear 66 may be positioned in front of the bracket 40. The worm gear 66 may be positioned next to the small diameter portion 56. The worm gear 66 may be rotated around a vertical axis. A portion of the worm gear 66 may face the front surface of the large diameter portion 54 in the front and rear direction X. The worm gear 66 may be spaced apart from the large diameter portion 54 in the front and rear direction X.

A portion of the lever 70, that is, the locking body 71, may be inserted into the pocket 25 as shown in FIG. 5, and the lever 70 may lock the pocket 25.

If the lever 70 is moved linearly as shown in FIGS. 5 and 6, the lever 70 may come out of the pocket 25, and the lever 70 may unlock the door 2.

The lever 70 may be formed with a protrusion (not shown) inserted into the guide rail 43. The protrusion may be formed on the lower surface of the locking body 71. The protrusion may be guided along the guide rail 43, and the locking body 71 may slide in the left and right direction Y along the guide rail 43 while being seated on the guide portion 42 where the guide rail 43 is formed.

A long hole 72, shown in FIGS. 7 to 9 through which a connecting rod 52 is guided may be formed in the lever 70. The long hole 72 may be formed orthogonal to the moving direction Y of the lever 70. The long hole 72 may be formed long in the up and down direction Z.

When the wheel 50 rotates, the connecting rod 52 may be guided from the bottom end of the long hole 72 to the top end of the long hole 72, and then from the top end of the long hole 72 to the bottom end of the long hole 72.

While the connecting rod 52 is guided to the long hole 72, the lever 70 may be pushed to the locking position P2 (shown in FIG. 8) or pulled to the unlocking position P1 (shown in FIG. 9) by the connecting rod 52.

The lever 70 may have a protruding body 74, shown in FIGS. 7 to 9 protruding.

When the lever 70 is in the locking position P2 as shown in FIG. 8, the protruding body 74 may be positioned other than between the light emitting portion 82 and the light receiving portion 84 of the photo sensor.

When the lever 70 is in the unlocking position P1 as shown in FIG. 9, the protruding body 74 may be positioned between the light emitting portion 82 and the light receiving portion 84 of the photo sensor.

The sensor 80 may comprise a photo sensor.

The photo sensor may be disposed such that the light emitting portion 82 and the light receiving portion 84 are spaced apart from each other.

The photo sensor may further comprise a sensor mounter 86 that supports the light emitting portion 82 and the receiving portion 84.

The light emitting portion 82 and the light receiving portion 84 may be mounted on the sensor mounter 86 so as to be spaced apart from each other in the up and down direction Z. A gap G, shown in FIG. 7 may be formed between the light emitting portion 82 and the light receiving portion 84.

The sensor mounter 86 may be mounted on a bracket 40 or a rocker mounter 16.

As shown in FIG. 9, the lever 70 may move linearly and enter the gap G, and the light of the light emitting portion 82 is not received by the light receiving portion 84 due to the protruding body 74, and the charger may sense the current position (unlocking position P2) of the lever 70 using the photo sensor.

If the lever 70 moves linearly as shown in FIG. 8, the light of the light emitting portion 82 may be received by the light receiving portion 84, and the charger may sense the current position (locking position P1) of the lever 70 using the photo sensor.

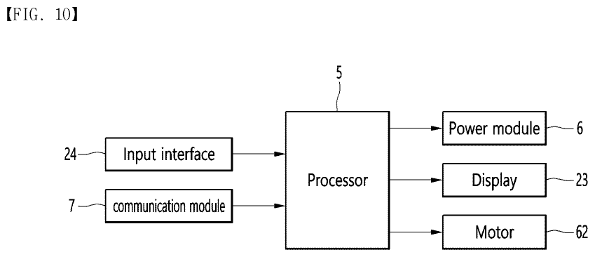

FIG. 10 is a control block diagram of a charger according to the present embodiment.

The charger may further comprise a processor 5.

The processor 5 may control the overall operation of the charger. The processor 5 may control the power module 6 accommodated in the charger body 1.

The processor 5 may output a signal according to the status information of the door 2 (e.g., locking or unlocking of the door 2) to the display 23, and the display 23 may display the status information.

The manager may check the current locking/unlocking of the door 2 through the display 23.

The manager may input the unlocking/locking of the door 2 through the input interface 24.

The processor 5 may output a control signal to the motor 62 when the locking or unlocking of the door 2 is input through the input interface 24.

The charger may further comprise a communication module 7 that communicates with a server (not shown). A personal computer or mobile phone may be connected to the server, and the manager may check the locking/unlocking of the door 2 through the personal computer or mobile phone, and input the unlocking/locking of the door 2 through the personal computer or mobile phone.

When the processor 5 receives a signal of locking or unlocking of the door 2 through the communication module 7, it may output a control signal to the motor 62.

That is, the manager may remotely lock/unlock the door 2.

The above description is merely an illustrative explanation of the technical idea of the present disclosure, and various modifications and variations will be possible to those skilled in the art without departing from the essential characteristics of the present disclosure.

Accordingly, the embodiments disclosed in the present disclosure are not intended to limit the technical idea of the present disclosure, but rather to explain it, and the scope of the technical idea of the present disclosure is not limited by these embodiments.

The scope of protection of the present disclosure should be interpreted in accordance with the claims below, and all technical ideas within the equivalent scope should be construed as being comprised in the scope of rights of the present disclosure.

1. A charger comprises:
a charger body provided with a space;
a door for opening and closing the space;
a bracket;
a wheel rotatably disposed on the bracket and having a connecting rod;
a driving source rotating the wheel;
a lever having a long hole through which the connecting rod is guided and moved linearly by the wheel and locked or unlocked on the door; and
a sensor sensing the lever.

2. The charger of claim 1,
wherein the lever is seated to the bracket.

3. The charger of claim 1,
wherein a guide portion for guiding the lever to slide is formed on the bracket.

4. The charger of claim 3,
wherein a guide rail is formed on the guide portion and the guide is long in the longitudinal direction of the bracket,
wherein a protrusion portion inserted into the guide rail is formed on the lever.

5. The charger of claim 1,
wherein the long hole is orthogonal to the moving direction of the lever.

6. The charger of claim 1,
Wherein the driving source comprises;
a motor;
a motor cover covering the motor; and
a worm gear rotated by the motor,
wherein the wheel is a worm wheel engaged with the worm gear.

7. The charger of claim 6,
wherein the motor is a brushed motor rotating the worm gear in one direction.

8. The charger of claim 6,
wherein the worm wheel comprises
a large diameter portion from which the connecting rod protrudes; and
a small diameter portion from which a gear engaged with the worm gear is formed on the outer periphery and which protrudes from the large diameter portion.

9. The charger of claim 1,
wherein the connecting rod is closer to a rim of the wheel among a center and the rim of the wheel.

10. The charger of claim 1,
wherein the sensor comprises a photo sensor in which a light emitting portion and a light receiving portion are disposed separately,
wherein a protruding body is protruded from the lever,
wherein the protruding body is positioned between the light emitting portion and the light receiving portion when the lever is in the unlocked position, and is positioned other than between the light emitting portion and the light receiving portion when the lever is in the locked position.

11. The charger of claim 1, further comprising;
a display disposed on at least one of the door or the charger body and having an input interface; and
a processor in configured to output a control signal to the motor if the door locking or door unlocking is input through the input interface.

12. The charger of claim 1, further comprising;
a communication module communicating with a server; and
a processor is configured to output a control signal to the motor if a signal of door locking or door unlocking is received through the communication module.
